(19) United States
(12) Patent Application Publication
(10) Pub. No.: US 2010/0211516 A1
(43) Pub. Date: Aug. 19, 2010

(54) METHOD AND SYSTEM FOR MATCHING EMPLOYERS WITH JOB-SEEKING INDIVIDUALS

(75) Inventors: Mark S. Andrekovich, Kinnelon, NJ (US); Nancy Kim, Marriottsville, MD (US); Kathryn T. Leggieri, Ephrata, PA (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: MAXIMUS

(21) Appl. No.: 12/487,981

(22) Filed: Jun. 19, 2009

Related U.S. Application Data
(60) Provisional application No. 61/202,329, filed on Feb. 19, 2009.

(51) Int. Cl. G06Q 10/00; G06Q 50/00; G06F 3/048

(52) U.S. Cl. 705/321; 715/760

(57) ABSTRACT

A system for proactively marketing job openings via an employment clearinghouse in communication with employers and outreach organizations serving potential employees is provided. The employment clearinghouse provides information and services related to employment; receives one or more job openings from an employer; geocodes the one or more job openings to determine a location for each of the one or more job openings; determines, for each of the one or more job openings, one or more outreach organizations within a predetermined distance of the location determined for the job opening; and presents the received one or more job openings to the one or more determined outreach organizations.

### RELATED APPLICATIONS

This application claims the benefit of priority under 35 U.S.C. §119(e) of U.S. Provisional Patent Application No. 61/202,329, filed Feb. 19, 2009, which is incorporated herein by reference.

### BACKGROUND

1. Technical Field

The present invention is related generally to methods and systems for matching employers with job-seeking individuals, and more particularly to methods and systems for proactively marketing job openings to targeted groups of job-seeking individuals.

2. Introduction

Businesses today rely heavily on the Internet to advertise job openings. Businesses often advertise job openings on job-posting websites or Internet job boards. In recent years there has been a proliferation of job-posting websites that typically allow a potential employer to post a job opening. Often there is a fee associated with posting a job opening. After job openings are posted to the job board, prospective employees may be able to search the posted job openings. Prospective employees may have an opportunity to apply to a job opening, or may have an opportunity to contact a prospective employer.

With the current job boards, there are many challenges to successfully marketing and filling job openings. For example, current job boards rely on the prospective employee finding, viewing, and responding to a job opening description. A prospective employee has to visit job board websites, search for job openings, etc.

Furthermore, current job sites present other problems. Currently there are many competing jobs sites. The competitive nature of the industry results in a fragmented market segment, increased expense in publicizing job sites, etc. Potential employees may navigate to one or more sites, but may not peruse them all. As a result, for maximum distribution employers must use many job sites. However, using many sites can be expensive. Also, because a job board may be open to the general public, employers may not be able to adequately target job openings to prospective employees in desired groups, geographic locations, etc. As a result, job openings may not be adequately filled.

Systems and methods consistent with embodiments of the present invention address these and other drawbacks of conventional employment systems.

### SUMMARY OF THE INVENTION

Additional aspects of the invention will be set forth in part in the description which follows, and in part will be obvious from the description, or may be learned by practice of the invention.

One embodiment of the present invention includes a method for proactively marketing job openings. The method may include receiving data about one or more job openings and geocoding the data about the one or more job openings to determine a location for each of the one or more job openings. The method may further include determining, for each of the one or more job openings, one or more outreach organizations within a predetermined distance from the location determined for the job opening and presenting the received data about the one or more job openings to the one or more determined outreach organizations.

Another embodiment of the present invention includes a system for proactively marketing job openings via an employment clearinghouse in communication with employers and outreach organizations serving potential employees. The system may include a public access section for providing information and services related to employment. The system may further include a community section for receiving one or more job openings from an employer, geocoding the one or more job openings to determine a location for each of the one or more job openings, determining, for each of the one or more job openings, one or more outreach organizations within a predetermined distance of the location determined for the job opening, and presenting the received one or more job openings to the one or more determined outreach organizations.

Another embodiment of the present invention includes a computer readable medium with computer readable code embodied therein for providing employment services, the computer readable code, when executed, causing a processor to receive data about a job opening from an employer, wherein the data includes a preference indicator of a desired employee type. The computer readable code, when executed, may further cause the processor to determine location information of the job opening based on the received data, identify, based on the preference indicator and the location information, an outreach organization related to potential employees of the desired employee type, and facilitate outreach to potential employees of the desired employee type via the identified outreach organization.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments of the invention and together with the description, serve to explain the principles of the invention. In the drawings:

FIG. 1 is a block diagram of a system for matching employers with job-seeking individuals, consistent with an embodiment of the present invention;

FIG. 2 is a block diagram of an employment clearinghouse in greater detail, consistent with an embodiment of the present invention;

FIG. 2A is a screen shot of an employment clearinghouse user interface, consistent with an embodiment of the present invention;

FIG. 3 is a block diagram of a community space in greater detail, consistent with an embodiment of the present invention;

FIG. 3A-3I are exemplary screen shots of an employment clearinghouse user interface, consistent with an embodiment of the present invention;

FIG. 4 is a block diagram of a management section in greater detail, consistent with an embodiment of the present invention;

FIG. 5 is a flow chart of a process for processing new outreach organizations, consistent with an embodiment of the present invention;

FIG. 6 is a flow chart of a process for proactively marketing new job openings, consistent with an embodiment of the present invention;

FIG. 7 is a flow chart of a process for creating a new job order, consistent with an embodiment of the present invention; and

FIG. 8 is a flow chart of a process for geocoding location information, consistent with an embodiment of the present invention.

### DETAILED DESCRIPTION

In searching for potential employees, employers often have many desired characteristics in mind. Beyond simply finding a candidate employee, employers may wish to target specific demographic groups. Employers may wish to improve company branding or target multi-lingual individuals, displaced workers or underrepresented ethnic groups, disabled individuals, veterans, seniors, female candidates, etc. Employers may seek to enrich the applicant pool, for example, to qualify for tax credits or to attract individuals in specific geographic areas.

Finding and communicating with desirable candidates may be difficult. For example, if prospective employees do not have Internet access, they may not be able to view a job opening. In addition, prospective employees may be unaware of the existence of the job board, and therefore may not know to search the job board for job openings. Low income employees often relied on community based organizations for job assistance and referrals.

System Overview

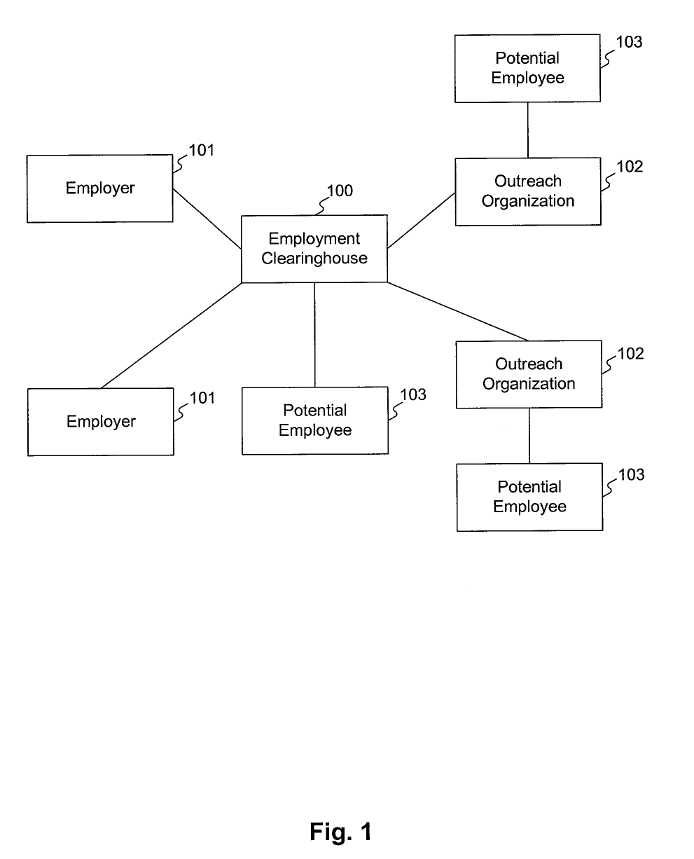

FIG. 1 is a block diagram of a system for matching employers with job-seeking individuals, consistent with an embodiment of the present invention. The system of FIG. 1 includes an employment clearinghouse 100, employers 101, outreach organizations 102, and potential employees 103. Systems consistent with the present invention may include any number of employers 101, outreach organizations 102, and/or potential employees 103. To proactively market job openings to potential employees 103 through outreach organizations, employers 101 may utilize employment clearinghouse 100.

Proactive marketing of job openings may include any process through which employers 101 seek to reach potential employees 103, for example, by using employment clearinghouse 100 and/or outreach organizations 102. In certain embodiments of the present invention, employer 101 submits job opening information (or job orders) to employment clearinghouse 100. Employment clearinghouse 100 may then process the job orders to one or more outreach organizations 102, such as those outreach organizations located in the area of employer 101. In one embodiment, employers 101 may provide job opening information to employment clearinghouse 100 through a website. Alternatively, employers could provide job opening information to employment clearinghouse 100 by telephone, e-mail, traditional mail, fax, etc. Similarly, employment clearinghouse 100 may provide job opening information to outreach organizations 102 through a website, by telephone, by e-mail, by traditional mail, by fax, etc. Outreach organizations may use any communication means to communicate information about job openings to potential employees 103, including through use of a website, by telephone, by e-mail, by traditional mail, by fax, by word of mouth, etc.

Outreach organizations 102 may include a variety of organizations associated with potential employees 103. In some embodiments, an outreach organization may be physically located in the area of the job opening. For example, outreach organizations may include non-profit organizations, for profit organizations, government funded organizations, job services, faith-based organizations, welfare organizations, ethnic-focused organizations, government agencies, and/or organizations providing services to disabled individuals and seniors.

Potential employees 103 may include diverse populations of candidates. In certain embodiments, potential employees 103 may include any individuals who turn to outreach organizations 102 for job assistance, referrals, etc. For example, potential employees 103 may include individuals with diverse cultural knowledge and language skills, displaced workers, disabled individuals, veterans, seniors, economically disadvantaged youth, etc. Potential employees 103 may also include hard-to-reach applicants for jobs in certain salary ranges. For example, potential employees 103 may include individuals in the $15,000 to $70,000 salary range, who may be difficult to reach using conventional employment systems but who may be active in outreach organizations such as faith-based groups or community groups. In another example, potential employees 103 may be individuals who meet criteria under government-sponsored programs, such as Work Opportunity Tax Credit (WOTC)-eligible employees.

Employers 101 may include any entities searching for potential employees 103. Employers 101 may set particular goals for hiring. For example, employers 101 may seek to receive tax credits by hiring members of certain demographic groups. In other examples, employers 101 may seek potential employees 103 with particular skills, located in particular geographic areas, etc. Employers 101 may, for example, seek individuals with diverse cultural knowledge and language skills, displaced workers, disabled individuals, veterans, seniors, economically disadvantaged youth, etc. Employers 101 may seek potential employees 103 for positions in certain salary ranges where finding employees is difficult. For example, employers 101 may seek potential employees 103 in the $15,000 to $70,000 salary range.

Employment clearinghouse 100 provides for receiving, storing, and distributing job opening information. Employment clearinghouse 100 may also provide the ability to integrate with other job boards, and thereby receive and share information about job openings. Employment clearinghouse 100 enables employers 101 to provide information about a new job opening. Employment clearinghouse 100 also facilitates distribution of information about new job openings to outreach organizations 102, which can in turn distribute information to potential employees 103. Employment clearinghouse 100 may also provide information about a new job openings directly to potential employees 103. Employment clearinghouse 100 may also permit assessment and collection of fees, including, for example, job posting fees, tiered fees such as preferred or featured postings, job broadcasting fees, job syndication fees, cross-posting fees for posting to affiliated job boards, banner advertising fees, print classified fees, resumé related fees, etc. Administrators of employment clearinghouse 100 may have the ability to set different pricing some customers. Employment clearinghouse 100 and/or outreach organization 102 may also provide career coaching resources, access to career articles, websites, advice, training, etc.

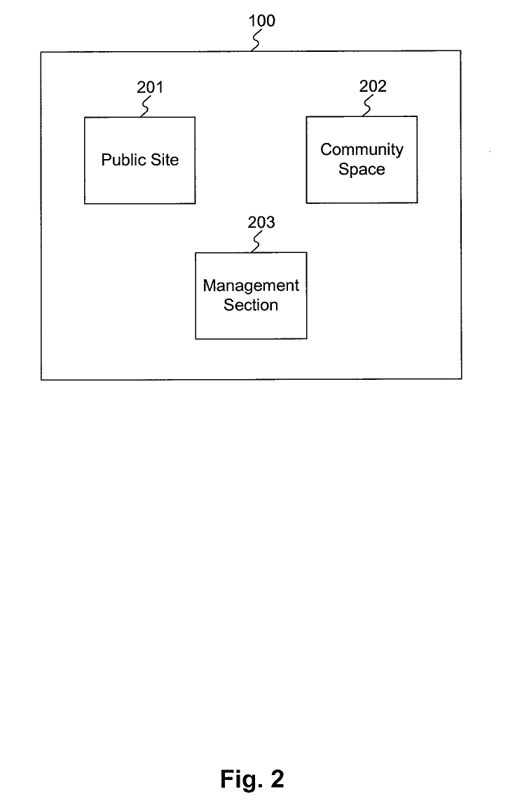

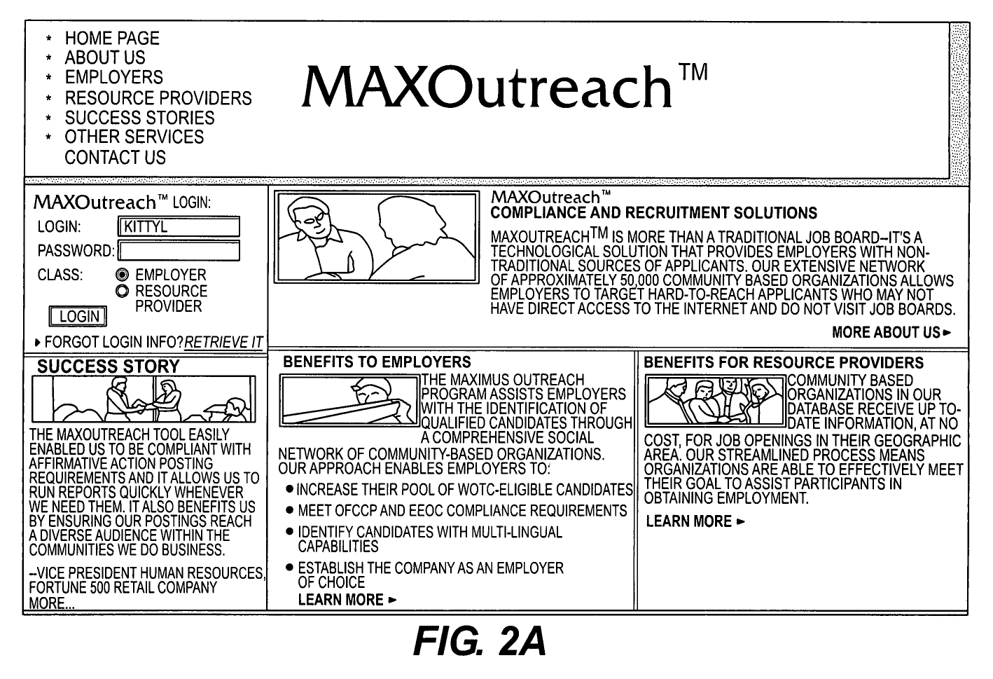

FIG. 2 is a block diagram of an employment clearinghouse in greater detail, consistent with an embodiment of the present invention. Employment clearinghouse 100 may include any hardware and/or software for facilitating proactive job marketing. Employment clearinghouse 100 may include, for example, public site 201, community space 202, and management section 203. As one skilled in the art will appreciate, employment clearinghouse 100 may include fewer or more components than those depicted in FIG. 2 and the components may be implemented in software and/or hardware.

Employment clearinghouse 100 provides functionality to employers 101, potential employees 103, and/or outreach organizations 102. For example, a national or international employer 101 may use employment clearinghouse 100 to manage job openings in many different locations. Employment clearinghouse 100 may provide tracking, reporting, analysis, and other functionality to assist employers 101 in managing employment-related tasks. In certain embodiments, employment clearinghouse 100 may provide a display for employers 101, such as a map (e.g., a geographic information system (GIS) map) depicting the locations of job openings, potential employees, employer locations, outreach organizations, etc.

Employment clearinghouse 100 may also provide an applicant Tracking/Candidate Management tool for employers 103 to track potential employees 101. Data related to each candidate may be organized in a candidate file that includes the candidate's resumé, contact information, an interaction history, results of any pre-screens, cover letters, communications, notes added by the employer, etc. Each potential job candidate can be easily managed with all of their information stored in one area.

Employers may create pre-screen filters using employment clearinghouse 100. These filters may allow employers to extract information about a candidate prior to contacting him. Employment clearinghouse 100 may enable employers to pose questions to potential employees including, for example, short text, long text, true/false, multiple choice, rate sets, etc. Point values may be associated with each response so that applicants may be automatically ranked. Disqualifiers may be assigned to questions so that unqualified candidates may be automatically filtered out and stored, for example, in a separate disqualified candidate list.

Employers may access a management template system via employment clearinghouse 100. This template system may enable employers to reuse job postings, pre-screen filters, automatic letters/notifications, etc. This system may make posting jobs a simple task and save the employers considerable time.

Employers may have use of an internal messaging system of employment clearinghouse 100 that may enable employers and job seekers to communicate. All messages sent from job seekers may be automatically stored. This may keep the recruitment process highly organized for both the employer and the job seeker. Additionally, employers are able to communicate with job seekers without using email. Employers may construct automated messages to be issued to job seekers via employment clearinghouse 100.

FIG. 2A is a screen shot of an employment clearinghouse user interface, consistent with an embodiment of the present invention. Public site 201 may include public information such as information about the clearinghouse service, information for employers 101, information for outreach organizations 102, information for potential employees 103, contact information, and other advertising information. Public site 201 may additionally contain a component for logging-in to community space 202. Employers 101 and/or outreach organizations 102 may gain access to community space 202 by contacting employment clearinghouse 100, e.g., by using contact information provided on public site 201. For example, an administrator of employment clearinghouse 100 may provide an employer 101 with a user name and password to access community space 202. Public site 201 may also enable job seekers 103, outreach organizations 102, and/or employers 101 to automatically create accounts.

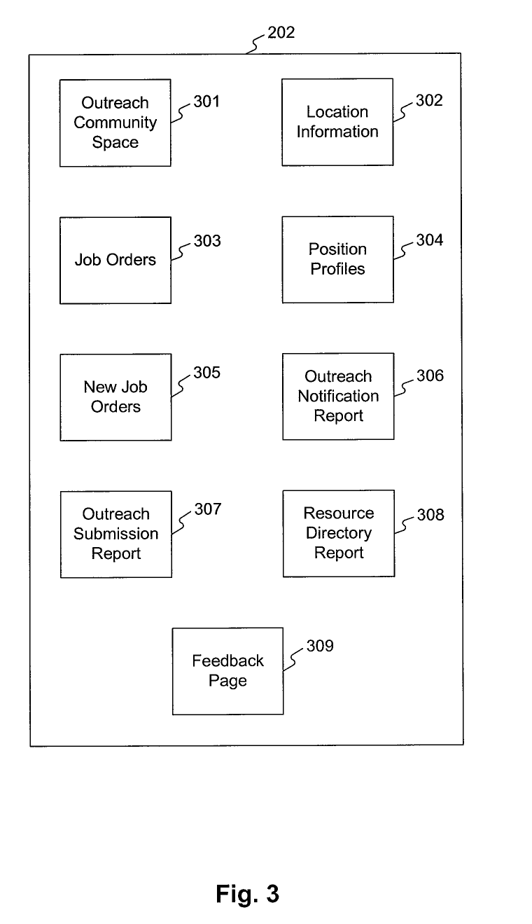

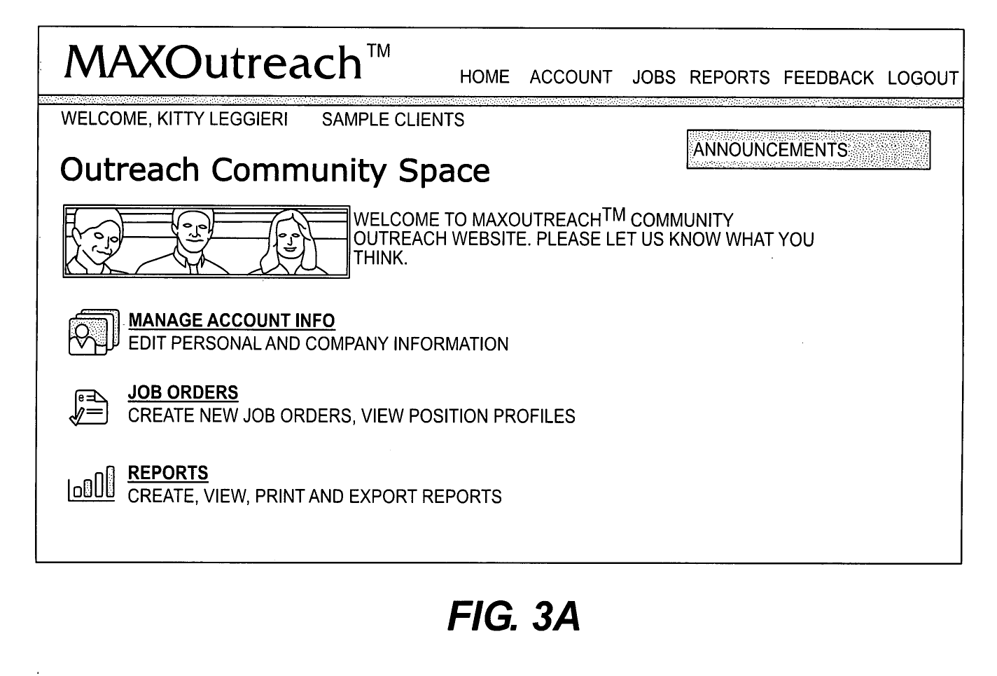

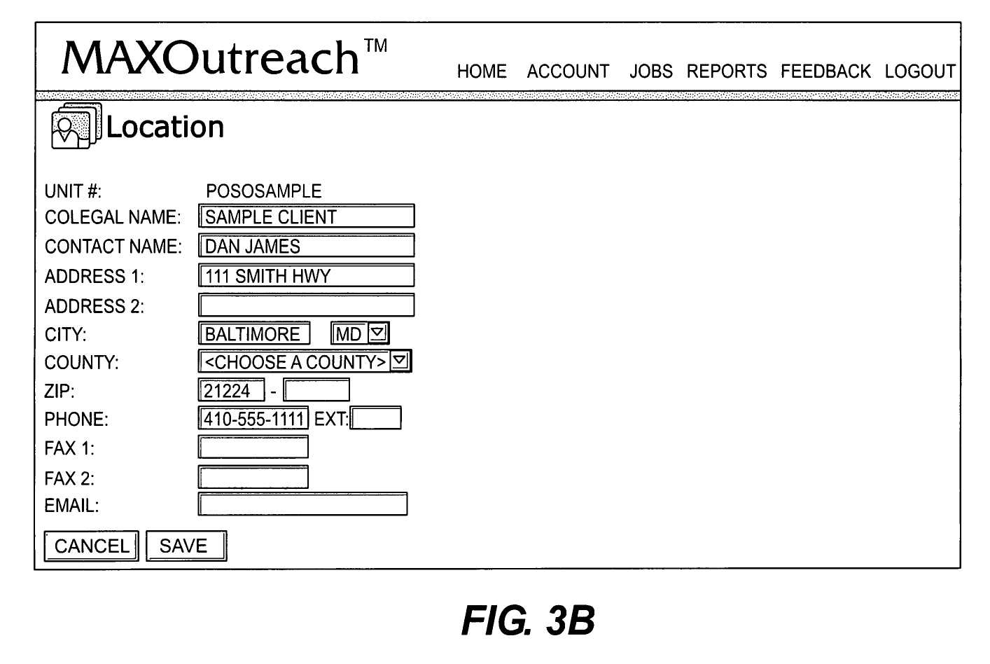

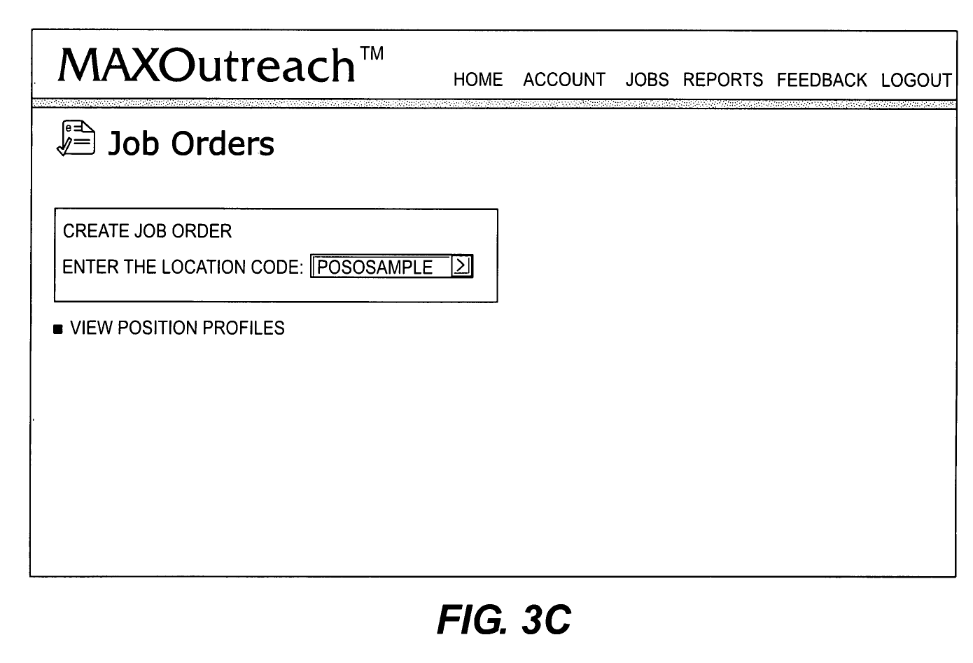

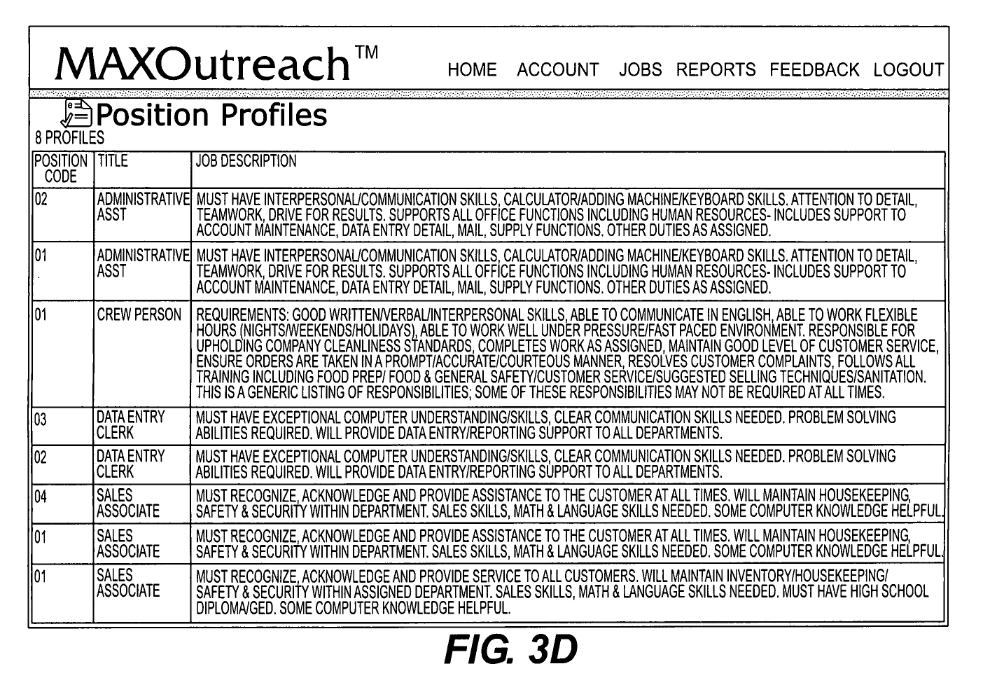

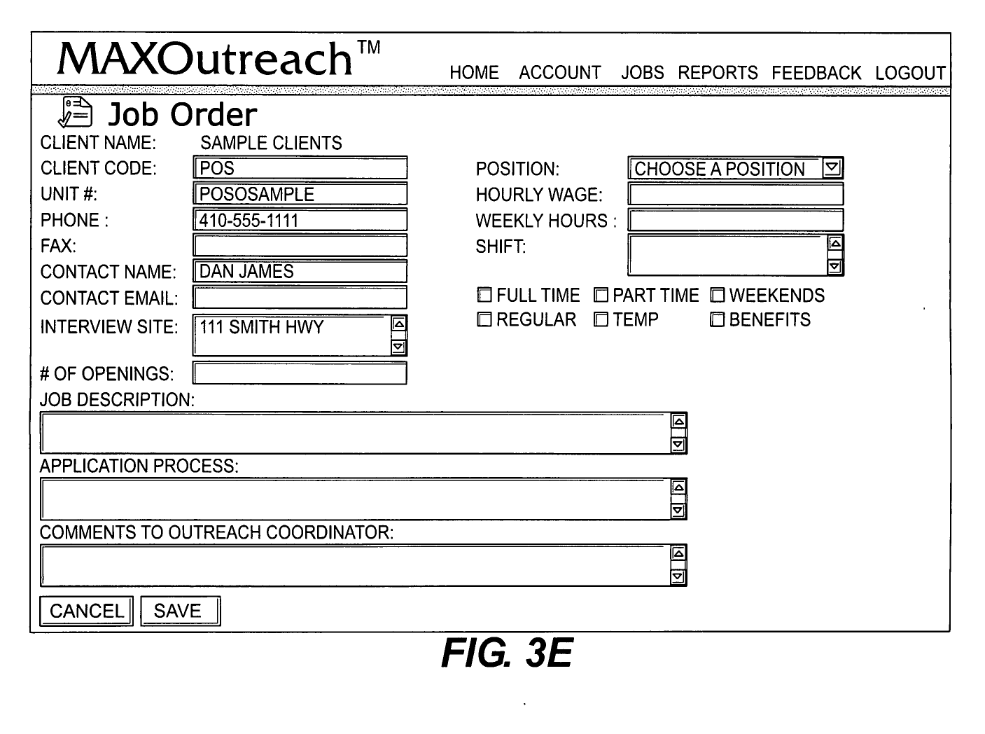

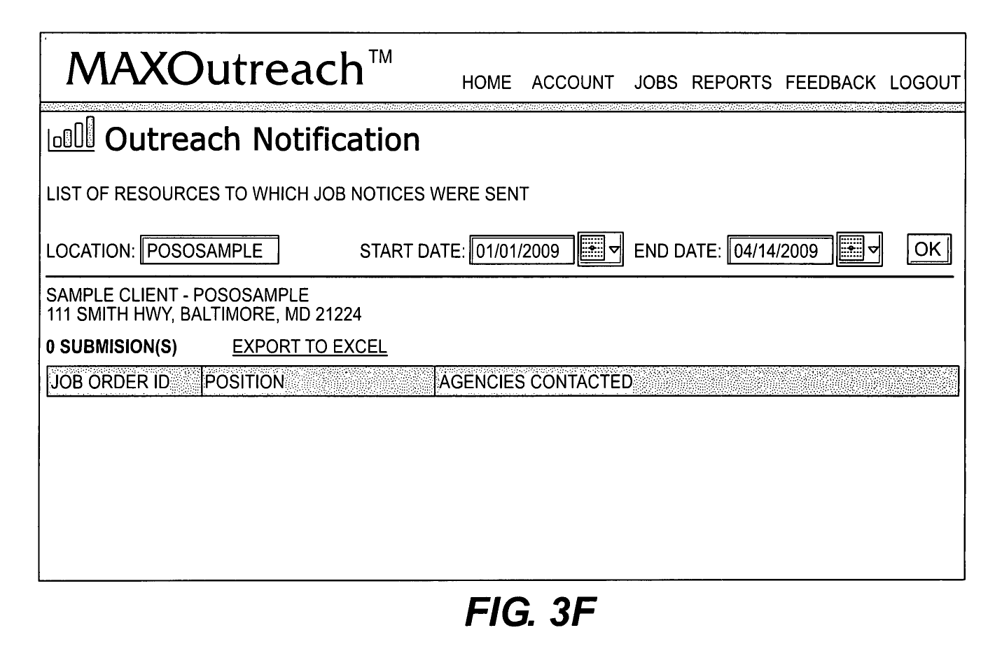

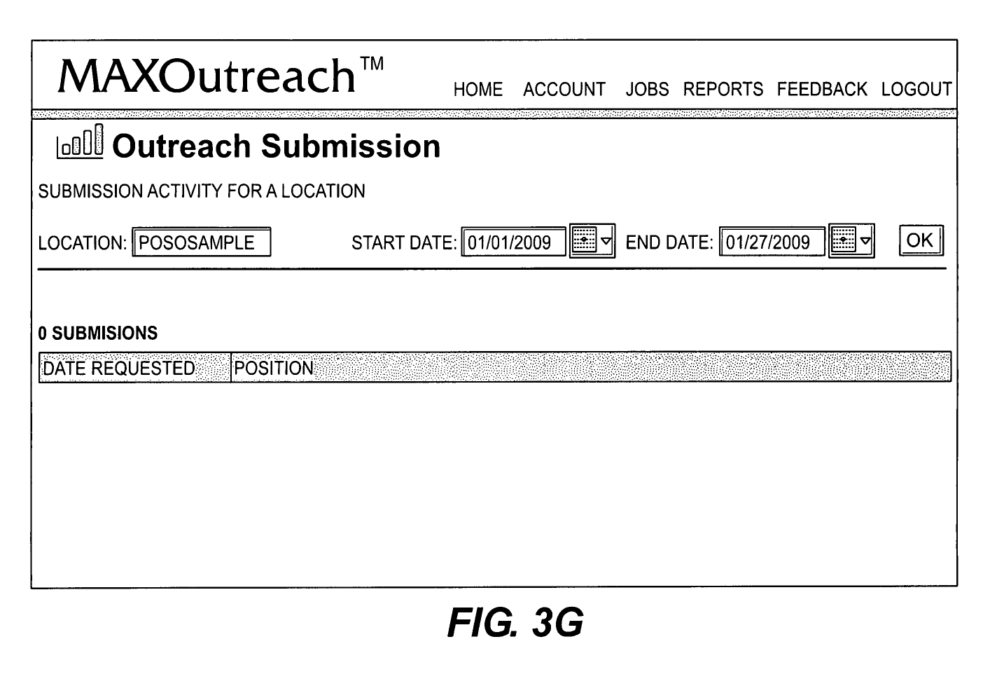

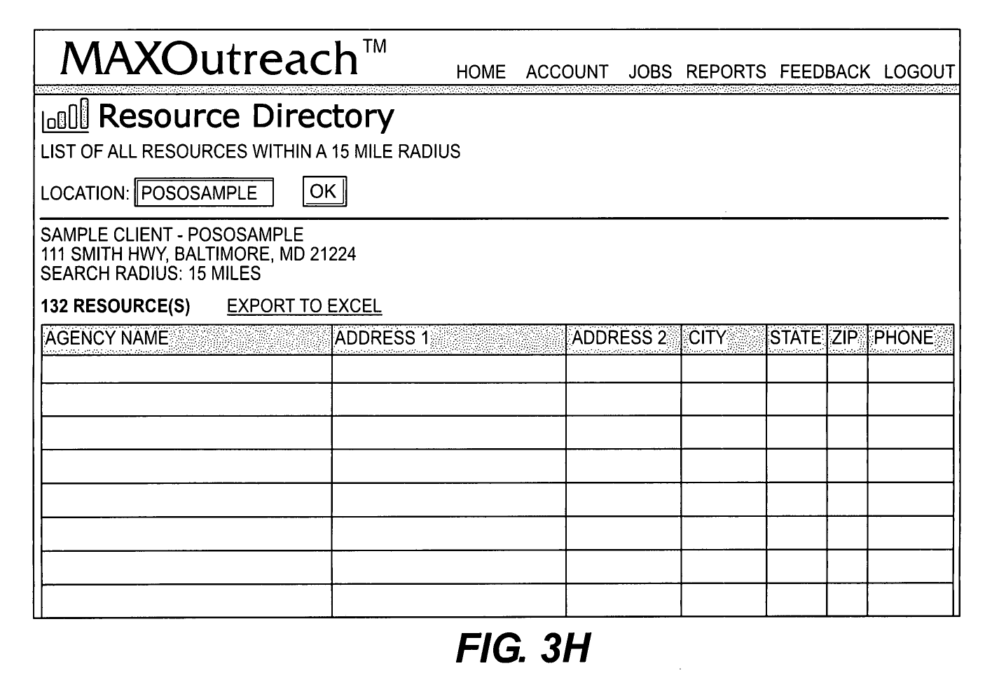

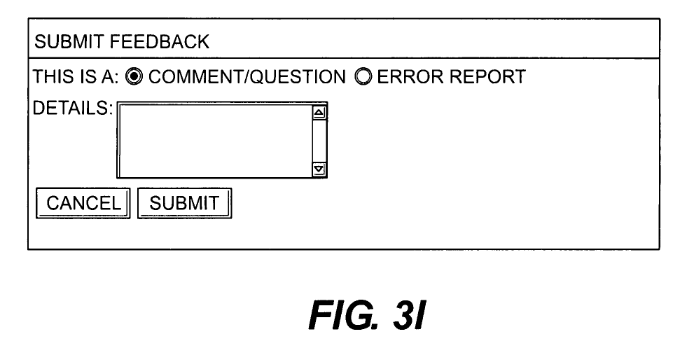

FIG. 3 is a block diagram of a community space in greater detail, consistent with an embodiment of the present invention. Community space 202 comprises components such as outreach community space 301, location information 302, job orders 303, position profiles 304, new job orders 305, outreach notification reports 306, outreach submission reports 307, resource directory reports 308, and feedback page 309. The components of community space 202 may be accessed, for example, via a drop-down list on community space 202, may be presented to a user or administrator as dialog boxes, may be presented as a series of links, may be implemented in hardware and/or software, etc.

FIG. 3A is an exemplary screen shot of an employment clearinghouse user interface, consistent with an embodiment of the present invention. Outreach community space 301 may allow an authorized user, such as employer 101, to view and edit account information; to view, edit, and create new job orders; and to create, view, print, and export reports.

FIG. 3B is an exemplary screen shot of an employment clearinghouse user interface, consistent with an embodiment of the present invention. Location information 302 may allow an authorized user to input and edit the data such as name, address, telephone number, and other contact information for an employer 101. Location information 302 may be presented to the user after the user selects “manage account information” from outreach community space 301.

FIG. 3C is an exemplary screen shot of an employment clearinghouse user interface, consistent with an embodiment of the present invention. Job orders 303 may allow an authorized user to view position profiles and to create new job orders, as described in more detail below. Job orders 303 may be presented to the user after the user selects “job orders” from outreach community space 301.

FIG. 3D is an exemplary screen shot of an employment clearinghouse user interface, consistent with an embodiment of the present invention. Position profiles 304 may allow an authorized user to view profiles about current positions, including, for example, position codes, titles, and job descriptions for current job postings associated with the user. In one embodiment, position profiles may be read-only to authorized users, and modifying the contents of position profiles 304 may require contacting employment clearinghouse 100. In other embodiments, employers 101 may edit, delete, and create position profiles.

FIG. 3E is an exemplary screen shot of an employment clearinghouse user interface, consistent with an embodiment of the present invention. New job orders 305 may allow an authorized user to create a new job order describing a job opening. The new job order may include, for example, the name of the potential employer, an employer code, an employer unit number, a phone number, a fax number, a contact name, a contact email, an interview site, a number of openings, a position, an hourly wage, weekly hours, job benefits, shift, a job title, a job description, application process information, a link to the employers website, license requirements, affirmative action goals, comments, etc. Other fields may also be provided, for example, for entering comments to an employment clearinghouse administrator. In one embodiment, an employer may include one or more outreach organization codes for a job opening. Outreach organizations 102 may be tagged with one or more outreach organization codes to designate the type of organization (e.g., non-profit, faith based, etc.). Outreach organization codes may be selected from a list of available codes provided by employment clearinghouse 100.

Employers may specify that only a subset of the job order information may be accessible to outreach organizations. Employers may also request a desired method of delivering job order information to outreach organizations, a timeframe for responses, etc. Additionally, employment clearinghouse 100 may compare new job orders to previously created job orders and may eliminate duplicates, outdated job orders, etc. As one skilled in the art will appreciate, new job orders 305 may include fewer or more components than those depicted in FIG. 3E.

Employment clearinghouse 100 also provides reporting functionality, for example, to monitor outreach activity, tailor outreach efforts, etc. Reports may, for example, track recent or monthly activity for an employer 101, outreach organization 102, etc. Some reports may be accessible to employers 101 through community space 202. Community space 202 may provide, for example, an outreach notification report 306, an outreach submission report 307, and a resource directory report 308.

FIG. 3F is an exemplary screen shot of an employment clearinghouse user interface, consistent with an embodiment of the present invention. An outreach notification report 306 may include a list of outreach organizations notified of a particular job opening. Outreach notification report 306 may include a location, a start date and end date, and a list of job orders that were submitted to outreach organizations 102. Outreach notification report 306 may also provide the ability to export data, for example, to spreadsheet files.

FIG. 3G is an exemplary screen shot of an employment clearinghouse user interface, consistent with an embodiment of the present invention. An outreach submission report 307 may include a list of job orders placed by an employer. Outreach submission report 307 may include a location, a start date and end date, and a list of submissions with corresponding dates. Outreach submission report 307 may also provide the ability to export data, for example, to spreadsheet files.

FIG. 3H an exemplary screen shot of an employment clearinghouse user interface, consistent with an embodiment of the present invention. A resource directory report 308 may include a list of outreach organizations within a predetermined radius of an employers address. Resource directory report 308 may include a location, employer information, and a list of resources available, for example, within a specified area relative to the location. The list of resources may include, for example, an outreach organization name, code, address, alternate address, city, state, ZIP code, and phone number. One skilled in the art will realize that other outreach organization information could also be included. Resource directory report 308 may also provide the ability to export data, for example, to spreadsheet files.

Some reports may be accessible only by administrators of employment clearinghouse 100. These reports may include, for example: all employer activity reports, which report all activity; activity by employers reports, which report activity for a specific employer; activity by state reports, which report activity in a particular state; employers within radius of outreach organization reports, which reports a list of all employers within a specified radius of an outreach organization; outreach organizations with missing or incorrect data reports, which report a list of outreach organizations 102 for which employment clearinghouse 100 has missing or incorrect data; outreach organization use reports, which reports a list of outreach organizations contacted, etc. Reports may be produced from a web program, and may be exported into spreadsheets.

FIG. 3I is an exemplary screen shot of an employment clearinghouse user interface, consistent with an embodiment of the present invention. Feedback page 309 may include a field for submitting an email address, a submission type, and a field for submitting text based feedback. Feedback page 309 may be used, for example, by employers 101, outreach organizations 102, etc.

Community space 202 may also include a potential employee section, which potential employees 103 may access after creating an account from public site 201 and then logging-in. Potential employee section may provide potential employees 103 the ability to search available jobs openings, save a list of selected jobs, apply for jobs, save a list of jobs applied to, create personal notes, send and receive messages, access career coaching materials, create and store resumes, receive alerts about new job openings, email job openings to other people, identify themselves as members of target groups (e.g. veterans, etc.), etc. In some embodiments, potential employees 103 may not need to create an account to access some or all of these features.

Community space 202 may include an outreach organization section, which outreach organizations 102 may access after creating an account from public site 201 and then logging-in. Outreach organization section may provide outreach organizations the ability to search available jobs openings, assist potential employees 103 in job searching, save a list of selected jobs, create notes, send and receive messages, access career coaching materials, receive alerts about new job openings, email job openings to other people, identify the organization as including members of target groups (e.g. veterans, etc.), etc. In some embodiments, outreach organizations 102 may not need to create an account to access some or all of these features.

One skilled in the art will appreciate that the components depicted as being part of community space 202 may be accessed from other parts of employment clearinghouse 100 (e.g., from management section 203). Furthermore, community space 202 may include fewer or more components than are depicted in FIG. 3, the components may be combined or arranged differently, and the components may be implemented in software and/or hardware.

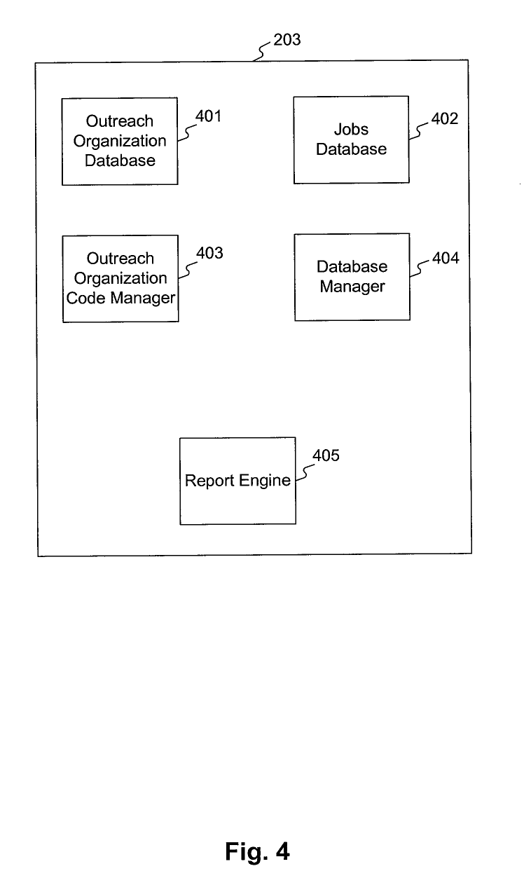

FIG. 4 is a block diagram of a management section in greater detail, consistent with an embodiment of the present invention. Management section 203 comprises components such as outreach organization database 401, jobs database 402, outreach organization code manager 403, database manager 404, and report engine 405. Outreach organization database 401 contains information about outreach organizations 102, such as organization name, code, address, alternate address, city, state, ZIP code, and phone number. Jobs database 402 stores job information, such as job postings. Jobs database 402 may include, for example, the name of the potential employer, a client code, a unit number, a phone number, a fax number, a contact name, a contact email, an interview site, a number of openings, a position, an hourly wage, weekly hours, shift, a job description, application process information, comments to an outreach coordinator, etc. Outreach organization code manager 403 provides the ability to manage outreach organization codes. These codes may identify the type of outreach organization (e.g., non-profit, government agency), the type of individuals served by the organization (e.g., ethnic group, income level), etc. Database manager 404 provides the database management, including, for example, providing the ability to add or delete data fields, create folders, edit stored information, view stored information, and store and secure files. Report engine 405 may generate, print, and distribute various reports including outreach notification reports 307, outreach submission reports 308, and resource directory reports 308. A skilled artisan will recognize that management section 203 may include more or fewer components than shown in FIG. 4, components may be combined, etc.

Outreach Process

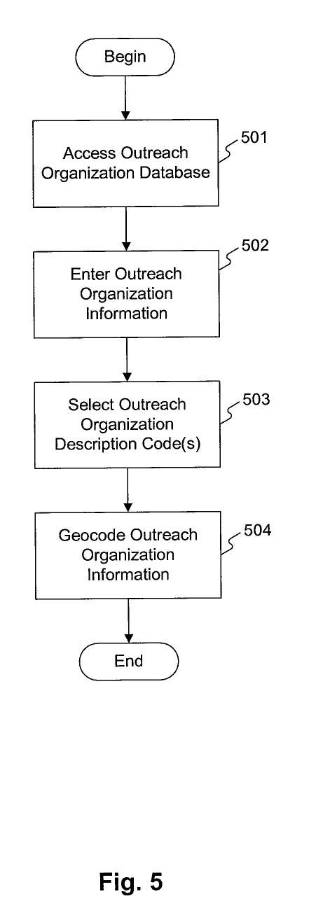

FIG. 5 is a flow chart of a process consistent with the present invention for managing outreach organizations. In certain embodiments, data about outreach organizations 102 may be stored in outreach organization database 401, which may be frequently updated. Update information may be received from many sources, including directly from an outreach organization 102, through research solicited by an employer 101, through research triggered by failed communications (e.g. by failed faxes), through employment clearinghouse 100, etc.

To add a new outreach organization 102 to outreach organization database 401, outreach organization database 401 is first accessed (step 501). This accessing may be done, for example, by an administrator of employment clearinghouse 100, by a member of outreach organization 102, etc. Accessing outreach organization database 401 may involve, for example, logging-in to community space 202 or management section 203. Information may then be entered for outreach organization 102 (step 502). After information is entered for outreach organization 102, an outreach organization designation code may be selected (step 503). An outreach organization designation code may be used to designate a specific type of outreach organization (e.g. a veteran's organization, an organization for a minority group, etc.). An outreach organization may then be geocoded (step 504). Geocoding an outreach organization, which is further discussed below, involves determining geographical location information for the outreach organization (for example, determining the latitude and longitude of the outreach organization). A skilled artisan will appreciate that the steps of FIG. 5 may be performed in different orders.

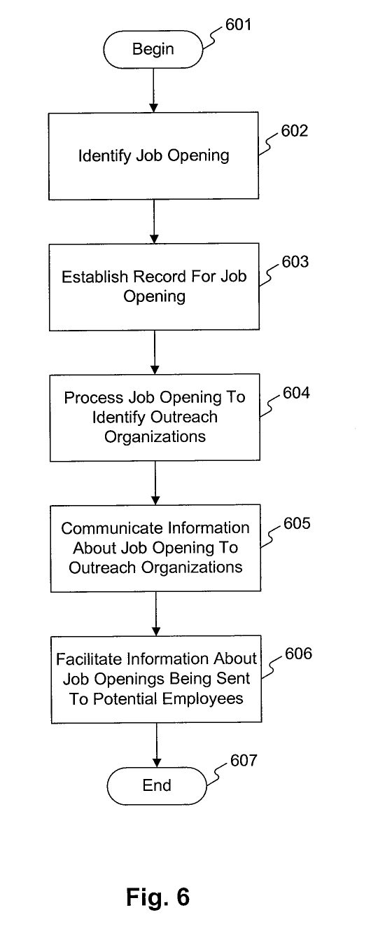

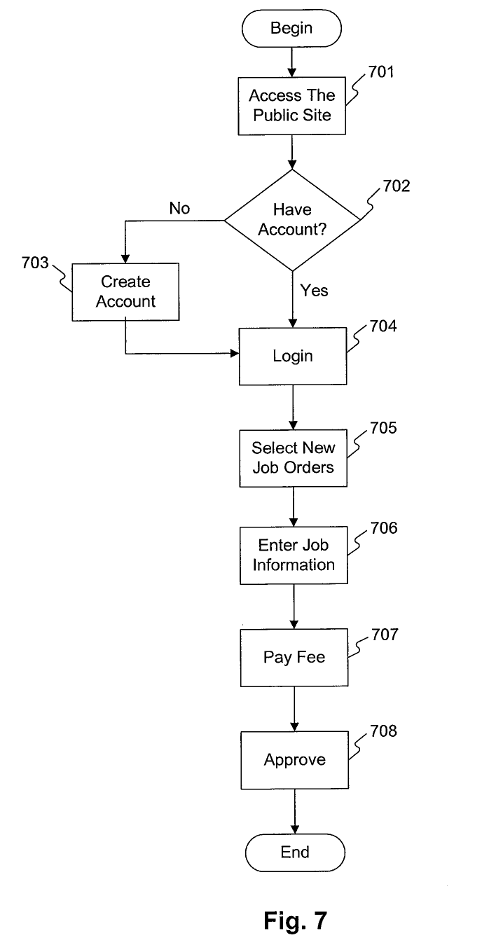

FIG. 6 is a flow chart of a process, consistent with the present invention, for proactively marketing new job opening. After a new job opening is identified (step 602), a record is established for the job opening (step 603). The process of establishing a record for a job opening is discussed in further detail with reference to FIG. 7. After establishing a record for a job opening, the job opening is processed to identify corresponding outreach organizations 102 (step 604). In some embodiments, to identify outreach organizations 102, employment clearinghouse 100 may compare employer location information with outreach organization location information in outreach organization database 401. Identifying outreach organizations may be done automatically, or it may be performed manually by a user or administrator. The processing may entail comparing certain variables including, for example, outreach organization codes, maximum radius requirements, etc. The comparison may search all outreach organizations within a specified radius from an employer location, organizations of a certain type, organizations serving a certain population, etc. The processing may limit the list of outreach organizations to those organizations which meet the certain parameters, etc. Information concerning the job opening may then be communicated to the identified outreach organizations (step 605). Job opening information may be communicated to the outreach organization via email, via telephone, via a website, via traditional mail, via fax, or via any other communication means. Employment clearinghouse 100 may facilitate sending, by the outreach organization(s) 102, information to potential employees 103 by, for example, providing the information by website, by telephone, by e-mail, by traditional mail, by fax, by advertising in group meetings, or through other communication means (step 606). In some embodiments, employment clearinghouse 100 may communicate directly with potential employees 103.

FIG. 7 is a flow chart of a process consistent with the present invention for creating a new job order. An employer 101 may access the employment clearinghouse public site 201 (step 701). If employer 101 has an account with the employment clearinghouse (step 702, YES), she may login (step 704). If employer 101 does not have an account (step 702, NO), she may create an account (step 703), and then login (step 704). The user may select the select to enter information about a new job order (step 705), for example, by selecting “Create Job Order” on the screen shot of FIG. 3C. The user may then enter job information (step 706), for example using the screen shown in FIG. 3E. The entered job information may include, for example, a job description field, salary information, employer industry information, job function information, employment type information, job duration information, educational requirements information, experience requirements information, job location information, and other information. The employer may pay a fee for the new job order (step 707), and may approve the job posting (step 708). In some embodiments, an administrator of employment clearinghouse 100 may provide assistance in developing and entering job information. In some embodiments, an administrator of employment clearinghouse 100 may review and approve new job orders.

In some embodiments, it may also be possible for an employer to fax, email, upload, or otherwise send job opening information directly to employment clearinghouse 100. In some embodiments a computer may process information submitted by fax, email, or other communication means and develop new job orders automatically from the information.

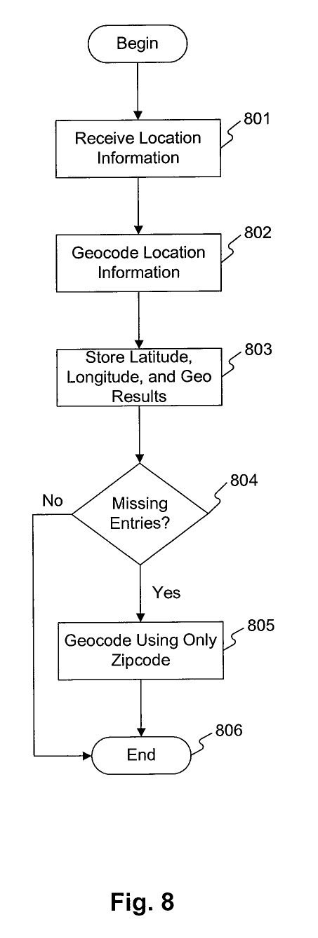

FIG. 8 is a flow chart of a process consistent with the present invention for geocoding location information. A process similar to the process shown in FIG. 8 can be used to geocode employer 101 location data, outreach organization 102 location data, etc. In the geocoding process, location information is received for one or more locations (step 801). Location information may include, for example, an address, a ZIP code, etc. In one embodiment, the location information may be contained in a spread sheet. In one embodiment, location information may be verified for accuracy. The location can be geocoded, e.g. using a geocoding program (step 802). The geocoding program may process address information to determine a latitude and longitude of the location. The latitude and longitude may then be associated with the location information and stored with the location information (step 803). Occasionally, geocoding in this manner may be unsuccessful. For example, some addresses may not be located successfully. This could happen, for example, if an address no longer exists. In this case (step 804, YES), latitude and longitude information may be determined using only the ZIP code portion of an address (step 805). Additionally, a geo result may be determined and stored with the latitude and longitude information. The geo result may be, for example, a code selected on the basis of the latitude and longitude information. In one embodiment, if the latitude and longitude result has six significant digits after a decimal point, a first geo result is used, but if the latitude and longitude have less than six significant digits after a decimal point, a second geo result is used. In another embodiment, rather than using the geocoding program to locate latitude and longitude information, this information may be manually determined.

Other embodiments of the invention will be apparent to those skilled in the art from consideration of the specification and practice of the invention disclosed herein. For example, an employment clearinghouse network could be used to provide other types of outreach to hard-to-reach populations. An entity desiring to communicate information, such as available low-cost healthcare services or changes to government programs such as welfare, could submit information postings with an employment clearinghouse. The information postings could be processed, for example, to match the postings to desired individuals and/or outreach organizations in the employment clearinghouse's network. In certain embodiments, the information postings could be geographically targeted. The employment clearinghouse could facilitate communicating information postings to outreach organizations and/or individuals to facilitate dissemination of information to hard-to-reach individuals.

In still other embodiments, the employment clearinghouse network could be used to manage information about hard-to-reach individuals. For example, an employment clearinghouse could use its network of outreach organizations to collect information from individuals, determine metrics about certain populations, assist individuals in participating in programs, etc. Employment clearinghouse network could be used to target information, including advertising, to certain individuals, employers, and/or outreach organizations.

It is intended that the specification and examples be considered as exemplary only, with a true scope and spirit of the invention being indicated by the following claims.

We claim:

1. A method for proactively marketing job openings, comprising:
receiving data about one or more job openings;
geocoding the data about the one or more job openings to determine a location for each of the one or more job openings;
determining, for each of the one or more job openings, one or more outreach organizations within a predetermined distance from the location determined for the job opening; and
presenting the received data about the one or more job openings to the one or more determined outreach organizations.

2. The method of claim 1, wherein geocoding the data about the one or more job openings further comprises:
using an address portion of the received data for a first job opening to determine a corresponding latitude and longitude; and
storing the latitude and longitude with the address portion of the received data for the first job opening.

3. The method of claim 1, further comprising:
displaying a map of the locations of the one or more job openings and the one or more outreach organizations.

4. The method of claim 1, wherein the one or more outreach organizations include at least one of:
a non-profit organization, a for profit organization, a government funded organization, a job service, a faith-based organization, a welfare organization, an ethnic-focused organization, a government agency, an organization providing services to disabled individuals, and an organization providing services to seniors.

5. The method of claim 1, further comprising:
reporting the determined outreach organizations to an employer associated with the one or more job openings.

6. A system for proactively marketing job openings via an employment clearinghouse in communication with employers and outreach organizations serving potential employees, the employment clearinghouse comprising:
a public access section for providing information and services related to employment; and
a community section for:
receiving one or more job openings from an employer;
geocoding the one or more job openings to determine a location for each of the one or more job openings;
determining, for each of the one or more job openings, one or more outreach organizations within a predetermined distance of the location determined for the job opening; and
presenting the received one or more job openings to the one or more determined outreach organizations.

7. The system of claim 6, wherein the community section further comprises a job openings list, a create new job openings tool, and reporting tools.

8. The system of claim 7, wherein the job openings list includes information about one or more existing job openings, and the information about the one or more existing job openings includes job titles and job descriptions for current job postings.

9. The system of claim 7, wherein the create a new job opening tool creates a new job opening using information including one or more of: the name of the potential employer, a client code, a unit number, a phone number, a fax number, a contact name, a contact email, an interview site, a number of openings, a position, an hourly wage, weekly hours, job benefits, shift, a job title, a job description, application process information, a link to the employers website, license requirements, affirmative action goals, and comments.

10. The system of claim 7, wherein the reporting tools include one or more of: outreach notification report, outreach submission report, resource directory report, all employer activity reports, activity by employers reports, activity by state reports, employers within radius of outreach organization reports, outreach organizations with missing or incorrect data reports, and outreach organization use reports.

11. The system of claim 6, wherein geocoding the one or more job openings further comprises:
using an address portion of the received data for a first job opening to determine a corresponding latitude and longitude; and
storing the latitude and longitude with the address portion of the received data for the first job opening.

12. The system of claim 6, wherein the community section further displays a map of the locations of the one or more job openings and the one or more outreach organizations.

13. The system of claim 6, wherein the one or more outreach organizations include at least one of:
a non-profit organization, a for profit organization, a government funded organization, a job service, a faith-based organization, a welfare organization, an ethnic-focused organization, a government agency, an organization providing services to disabled individuals, and an organization providing services to seniors.

14. A computer readable medium with computer readable code embodied therein for providing employment services, the computer readable code, when executed, causing a processor to perform the steps of:
receiving data about a job opening from an employer, the data including a preference indicator of a desired employee type;
determining location information of the job opening based on the received data;
identifying, based on the preference indicator and the location information, an outreach organization related to potential employees of the desired employee type;
facilitating outreach to potential employees of the desired employee type via the identified outreach organization.

15. The computer readable medium of claim 14, the steps further comprising:
reporting the outreach to the employer.

16. The computer readable medium of claim 14, wherein the identifying further comprises determining location information of the outreach organization.

17. The computer readable medium of claim 14, wherein the outreach organization is one of:
a non-profit organization, a for profit organization, a government funded organization, a job service, a faith-based organization, a welfare organization, an ethnic-focused organization, a government agency, an organization providing services to disabled individuals, and an organization providing services to seniors.

18. The computer readable medium of claim 14, the steps further comprising:
displaying a map of the job opening and the outreach organization.

19. The computer readable medium of claim 14, the steps further comprising:
compiling a list of outreach organizations related to potential employees;
coding each outreach organization according to the employee type served by the outreach organization; and
enabling the employer to designated the coding of desired outreach organizations.

20. The computer readable medium of claim 14, the steps further comprising:
displaying a map of a plurality of job openings associated with the employer and locations of employees of the desired employee type.
